(19) United States
(12) Patent Application Publication
(10) Pub. No.: US 2024/0343485 A1
(43) Pub. Date: Oct. 17, 2024

(54) MAINTENANCE SYSTEM FOR A TRANSPORT AND STORAGE FACILITY

(71) Applicant: EXOTEC PRODUCT FRANCE, CROIX (FR)

(72) Inventors: Loïc LEPILLIER, WATTRELOS (FR); Victor IGLA, HASNON (FR); Renaud HEITZ, VILLENEUVE D'ASCQ (FR)

(73) Assignee: EXOTEC PRODUCT FRANCE, CROIX (FR)

(21) Appl. No.: 18/632,479

(22) Filed: Apr. 11, 2024

(30) Foreign Application Priority Data
Apr. 11, 2023 (FR) 2303593

(51) Int. Cl. B65G 1/04; B66F 11/04

(52) U.S. Cl. CPC B65G 1/0492; B66F 11/042; B66F 11/046

(57) ABSTRACT

A maintenance system for a transport and storage facility including storage racks arranged so as to form at least one access aisle, the maintenance system having a supporting chassis, a mobile platform intended to receive an operator, a lifting device interposed between the mobile platform and the supporting chassis, and configured to make it possible to raise the mobile platform and retract it towards the supporting chassis, and a device for vertically guiding and stabilizing the mobile platform, the vertical guiding and stabilizing device having at least one guide member configured to interact with a storage rack upright facing onto the respective access aisle.

### FIELD

The present invention relates to the field of maintenance for facilities for transporting and storing articles in warehouses, particularly for automated transport and storage facilities, commonly referred to as automated storage and retrieval systems (ASRS). More particularly, the present invention relates to a maintenance system for such a transport and storage facility.

### BACKGROUND

In the field of logistics, it is known to create article storage facilities, for example in warehouses, that are compact and extend upwards in order to optimize the storage space available. Such a transport and storage facility generally comprises storage racks arranged compactly, and access aisles serving storage racks on either side. The storage racks are intended to accommodate and store articles and to this end define successive columns of compartments within their structure, each compartment defining a bin location. These compartments are intended to receive bins, or more generally containers, in which articles are placed and stored. Said articles are then brought together to make up orders.

Some storage facilities, known as ASRS, implement automated guided vehicles, particularly configured to place articles on and retrieve them from said storage racks. The automated guided vehicles, hereinafter referred to by their abbreviation AGV, are generally robots that move autonomously without human intervention. The AGVs can for example be shuttles, forklift trucks, storage and retrieval machines, or robots. The AGVs can for example move in at least one direction, or in both directions of a horizontal surface, which can typically be the floor of the warehouse. The automated guided vehicles can also move vertically by climbing the storage racks. Such storage facilities are in particular disclosed in WO 2019/072432. To this end, the vehicles are typically provided with climbing means such as motorized toothed wheels meshing with a climbing element (typically a toothed rack or a roller chain) arranged over the height of a rack upright. From time to time, a vehicle can become positioned at an angle and immobilized at height, requiring recovery.

In such an event, a mobile aerial lift comprising an extendible structure mounted on a truck chassis, self-propelled or otherwise, is used to position at height a work platform able to receive an operator, particularly in order to carry out maintenance work at height. The extendible structure is for example made up of articulated and/or telescopic arms. Such mobile aerial lifts have the advantage of being flexible, and in particular of being able to be moved easily from one access aisle to another. However, these mobile aerial lifts do not make it possible to reach elevated heights in the context of a compact transport and storage facility, unless they are stabilized using means with a large footprint (in terms of weight and/or space occupied on the floor), which in turn affects the flexibility offered by this type of lift.

This mobile aerial lift is a flexible solution used by the present applicant for carrying out maintenance at height and particularly to permit the recovery of a vehicle immobilized at height in an ASRS.

Documents FR 2 919 591 B1 and DD 252 815 A1 also disclose a lift installed in each of the access aisles, and used both to raise and lower the articles so that they can be placed in and retrieved from the compartments, and to carry out maintenance or assembly work at height by an operator.

In these documents, the lift comprises a support mast and a work platform that can be translated vertically relative to the mast, guided by the mast. The mast is fastened at two vertical ends to the floor and ceiling of the facility respectively. The mast is mounted at two vertical ends on rails along the corresponding aisle, the rails being fastened to the floor and ceiling of the facility respectively, so as to allow the lift to translate along the rails in the aisle. Anchoring the lift to the floor and ceiling makes it possible to ensure stability permitting the raising and lowering of loads over an elevated height, namely of more than a dozen metres. However, this solution has a large footprint and is inflexible, as it requires one lift per aisle, and if applicable, the arrangement of rails on the floor and ceiling in every aisle.

JP2003-095407 A describes another type of lift for raising or lowering an article or a vehicle on a storage rack and placing it in or retrieving it from a compartment of the rack. The lift moves laterally to the rack in a trench arranged in an aisle between two racks and essentially comprises a platform that can be translated vertically in the aisle, by means of a lifting device made up of a winch mounted in a rail at the top of each of the racks and a hydraulic raising and lowering device positioned under the platform. A cart is further arranged on the platform in order to deposit or retrieve the article or the vehicle from a compartment of a rack. This solution, which is not suitable for receiving a maintenance operator due to the presence of the cart on the platform, has the same drawbacks in terms of footprint and lack of flexibility as the lifts in FR 2 919 591 B and DD 252 815 A1.

According to the applicant's observations, the rails on the floor further form obstacles to the movement of automated guided vehicles around ASRS facilities; such a lift is a maintenance solution that is not compatible with ASRS facilities.

There is therefore a need for a flexible maintenance system having a small footprint for carrying out maintenance operations at height in a transport and storage facility.

### SUMMARY

The present disclosure improves this situation.

A maintenance system is proposed for a transport and storage facility comprising storage racks arranged so as to form at least one access aisle between two respective storage racks. The storage racks comprise vertical uprights. The maintenance system comprises a supporting chassis capable of moving around on the floor in the at least one access aisle, a mobile platform intended to receive an operator, and a lifting device interposed between the mobile platform and the supporting chassis. The lifting device comprises at least a base part rigidly connected to the supporting chassis, a mobile part rigidly connected to the mobile platform, and an extending mechanism configured to deploy the mobile part upwards in order to raise the mobile platform, and retract it towards the supporting chassis in a minimal vertical footprint position of the maintenance system. The maintenance system comprises a guiding and stabilizing device for the mobile platform, the vertical guiding and stabilizing device comprising at least one guide member configured to interact with an upright facing onto the respective access aisle.

The maintenance system according to the present invention offers the considerable advantage of being able to be mobile, flexible and having a small footprint, and of being able to reach a more elevated height compared to a maintenance vehicle without a guiding and stabilizing device. The guiding and stabilizing device offers improved stability of the maintenance system, to allow an operator to carry out operations at height in complete safety, while reducing the footprint of the maintenance system, in terms of space occupied on the floor and/or weight. In addition, such a maintenance system does not require the installation of additional infrastructure in the transport and storage facility, for example guiding or anchoring infrastructure, on the floor or ceiling of the transport and storage facility. The maintenance system can move around freely in the access aisles.

In the description hereinafter, reference is made to a first direction, a second direction and a third direction. The first direction coincides with a vertical direction in particular extending vertically from the floor of the transport and storage facility. The first direction is perpendicular to the second direction and the third direction. The second direction is perpendicular to the third direction. It will therefore be understood that the second direction and the third direction form horizontal directions, here orthogonal to each other.

The features disclosed in the following paragraphs can optionally be implemented independently of each other or in combination with each other.

Advantageously, the mobile platform and/or the mobile part of the extending mechanism can comprise the vertical guiding and stabilizing device. As the mobile part of the extending mechanism is rigidly connected to the mobile platform, the guiding and stabilizing device can be positioned on this mobile part while making it possible to guide and stabilize the mobile platform during the extension and retraction thereof. In short, the vertical guiding and stabilizing device must advantageously be able to rise upwards and retract with the chassis, following the raising and lowering movement of the mobile platform to ensure the guiding and stabilizing at height thereof. It can also be envisaged that the mobile platform and the mobile part of the extending mechanism each respectively comprise a vertical guiding and stabilizing device.

Advantageously, the vertical guiding and stabilizing device comprises a deployment mechanism configured to move said at least one guide member of the vertical guiding and stabilizing device from a disengaged position from an upright to an engaged position with the respective upright. The implementation of a deployment mechanism advantageously makes it possible to reduce the footprint of the maintenance system when the at least one guide member is not in the engaged position on the respective upright, particularly when the maintenance system is moving around in an access aisle.

Advantageously, said at least one guide member is configured to ensure linear guiding of the mobile platform along the respective upright. The guiding must in particular make it possible to ensure that the guide member presses against the upright while limiting the friction of the guide member and the respective upright.

Said at least one guide member of said vertical guiding and stabilizing device can advantageously comprise at least one vertical guide wheel intended to roll against an upright, the vertical guide wheel having an axis of rotation perpendicular to a longitudinal direction of the upright. Other guiding alternatives can be envisaged.

The guide member can be configured to ensure linear ball guiding of the mobile platform along the respective upright. This type of guiding makes it possible to reduce the contact friction and pressure between the surfaces of the guide member and the upright, thus offering precise movement of the guide member relative to the upright.

The guide member can be configured to ensure linear roller guiding of the mobile platform along the respective upright. To this end, the guide member can comprise one or more cylindrical rollers. This type of guiding makes it possible to reduce the friction between the guide member and the upright. This type of guiding has the advantage of being more durable and being able to withstand heavier loads than ball guiding.

The guide member can be configured to ensure linear shoe guiding of the mobile platform along the respective upright. This type of guiding makes it reduce the friction between the sliding surfaces between the guide member and the respective upright. This type of guiding is in particular advantageous for applications requiring rapid, repetitive movements.

The guide member can be configured to ensure linear magnetic guiding of the mobile platform along the respective upright. This type of guiding in particular implements magnetic fields to make it possible to support the load of the mobile platform. This type of guiding offers the advantage of limiting the friction between the guide member and the upright, and ensuring precision and a large load capacity.

The guide member can be configured to ensure linear slider guiding of the mobile platform along the respective upright. The guide member can be configured to interact with the respective upright in the form of a guide rail. In particular, the guide member and the respective upright are configured to be in surface-to-surface contact with each other so as to form a sliding connection. The guide member and the respective upright are particularly made from a material having a sufficiently low coefficient of friction to allow satisfactory operation of the sliding connection. The guide member and the guide rail can be made from steel for example. This solution has the advantage of being simple and low-cost. It can be advantageous in applications requiring linear movements to travel over long distances.

Advantageously, said vertical guiding and stabilizing device comprises a prestressing mechanism intended to exert pressure from said at least one guide member against an upright. This makes it possible to compensate for any play between the guide member and the upright along the latter. In particular, when the aim is to reach elevated heights, as in this invention, the upright can have a deflection relative to the first direction. The prestressing mechanism makes it possible to compensate for this deflection and ensure the stability of the mobile platform up to the maximum height that it can reach.

The prestressing mechanism can comprise a spring member configured to elastically stress said at least one guide member onto the upright while compensating for play over the height of the uprights.

Advantageously, the deployment mechanism can comprise an operating device configured to move said at least one spring member from a less stressed, or even unstressed, state in the disengaged position of said at least one guide member, to a more stressed state of said at least one guide member, in the engaged position of the guide member.

Advantageously, the vertical guiding and stabilizing device comprises at least one pair of guide members. Each guide member of the pair of guide members can in particular be configured to press on a respective upright in the same direction but in the opposite way from the pressure of the other guide member of the pair of guide members on a respective upright. This makes it possible to ensure improved stability of the mobile platform during the guiding at height of the mobile platform. One pair, for example each pair, of the at least one pair of guide members can advantageously be intended to interact with uprights positioned respectively on either side of a respective access aisle. This makes it possible to ensure that the mobile platform is guided on either side of the respective access aisle. Alternatively, the guide members of one pair of guide members, particularly of each pair, can be intended to interact with the same upright, or with two uprights positioned in the same row of uprights.

The vertical guiding and stabilizing device can comprise one pair of guide members, two pairs of guide members, or more than two pairs of guide members. The number of pairs of guide members, their configuration and their positioning relative to the maintenance system is in particular suitable for ensuring the stability at height of the mobile platform and the mobile part of the extending mechanism. The number of pairs of guide members and their positioning can particularly correspond to a length of the mobile platform and the maximum height for the deployment of the mobile part of the extending mechanism.

The implementation of a guiding and stabilizing device comprising an odd number of guide members can also be envisaged. The important aspect is that the number of guide members, their configuration and their positioning make it possible to ensure the stability of the mobile platform, particularly in a plane substantially perpendicular to the first direction, during its extension upwards and during its retraction.

Advantageously, said maintenance system is such that the extending mechanism is configured to deploy the mobile part up to a maximum height greater than or equal to 10 m, particularly greater than or equal to 12 m. The maintenance system can have a weight less than or equal to 500 kg and occupy, in particular the supporting chassis, a maximum floor space less than 1,500 mm in length, particularly 1,200 mm, and less than 750 mm in width, particularly 700 mm. Space occupied on the floor is given to mean the maximum circumferential area occupied by the maintenance system on the floor. These features make it possible to ensure the flexibility and manoeuvrability of the maintenance system, due to a reduced footprint of the maintenance system in terms of space occupied on the floor and weight, while making it possible to reach an elevated maximum height.

In particular, the footprint of the maintenance system is advantageously such that it corresponds to a footprint of a conventional commercially available mobile aerial lift, as described above. In particular, the footprint of the mobile platform can correspond to the footprint of an assembly made up of the basket and mast of such a conventional mobile aerial lift. The present invention thus makes it possible to easily adapt a commercially available mobile aerial lift, particularly by adding thereto the vertical guiding and stabilizing device, in order to make it possible to raise the mobile platform over a greater height than the conventional mobile aerial lift without making it necessary to increase the space occupied on the floor of the conventional mobile aerial lift in order to ensure the stability thereof.

The guide member can in particular be configured to interact with different upright profiles. More specifically, the guide member can be configured to come up against at least one bearing surface of a respective upright, the bearing surface extending in a plane the normal of which is perpendicular to the first direction. For example, the guide member can be configured to come up against a single bearing surface, or two bearing surfaces of a respective upright, or even more than two bearing surfaces. The interaction of the guide members with the bearing surfaces is particularly suitable for preventing the movement of the guiding and stabilizing device in a plane perpendicular to the first direction when it is engaged on the uprights.

Advantageously, the supporting chassis comprises two pairs of wheels for the system to move around on the floor. The supporting chassis can comprise a motorized or non-motorized vehicle.

Advantageously, said supporting chassis is provided with at least one horizontal guiding device extending lengthwise along the supporting chassis and configured to interact with elements of storage racks, in discontinuous positions along the length of the access aisle in order to ensure the guiding of the maintenance system along the access aisle. It is thus easier to correctly position the maintenance system in the access aisle in order to be able to facilitate the manoeuvrability of the maintenance system and the engagement of the maintenance system on the uprights.

The extending mechanism configured to deploy the mobile part upwards in order to raise the mobile platform, and retract it towards the supporting chassis in the reduced vertical footprint position of the maintenance system, can comprise at least one, for example one or more, telescopic mast(s) or a scissor-lift mechanism.

According to another aspect, a transport and storage facility is proposed, comprising storage racks comprising successive columns of compartments. In particular, each of the compartments defines a bin location intended to receive one or more articles, for example arranged in a bin. The storage racks are in particular arranged so as to form at least one access aisle between two respective storage racks. The storage racks comprise vertical uprights. The facility further comprises a maintenance system as described above, configured to move around in the at least one access aisle. The at least one guide member of the vertical guiding and stabilizing device of the maintenance system is configured to interact with a storage rack upright facing onto a respective access aisle.

Advantageously, each of the at least one access aisles, between two respective storage racks, is made up of a plurality of successive vertical access columns, each vertical access column serving at least one respective column of compartments. The installation further comprises at least one automated vehicle configured to be raised or lowered in a vertical access column. The vehicle can be an automated guided vehicle, or AGV. Each of the at least one vehicle(s) comprises climbing means suitable for interacting with uprights of the storage racks facing onto said vertical access column. The maintenance system is then in particular configured to make it possible for an operator to carry out operations at height, particularly assembly and/or maintenance operations, and in particular operations to maintain a vehicle. The vehicle can, in operation, be immobilized at height in a vertical access column, for example due to a breakdown. The vehicle can become positioned at an angle, butted against the climbing elements, that is, the chassis of the vehicle is inclined relative to a horizontal plane perpendicular to the first direction. The maintenance system makes it possible for an operator to intervene at height in order to release the vehicle. In addition, the maintenance system does not require the installation of infrastructure on the floor, for example guiding or anchoring infrastructure, thus making it possible to facilitate the movement of vehicles in the access aisles, and even under the storage racks if applicable.

Advantageously, the climbing means of the at least one vehicle arranged in a vertical access column and the vertical guiding and stabilizing device of the mobile platform guided in an adjacent access column, are configured to interact simultaneously with the same upright of one of the storage racks without hindering the movement, along the direction of the upright, of the respective vehicle or the respective mobile platform relative to said same upright. This feature advantageously makes it possible to bring the maintenance system as close as possible to an immobilized vehicle to perform maintenance on it.

According to another aspect, a method for maintaining a facility as described above is proposed. The method comprises:
moving the maintenance system to a vertical access column succeeding a vertical access column in which a vehicle is immobilized,
coupling the guide member of the vertical guiding and stabilizing device to an upright facing onto the respective access aisle,
deploying the mobile platform to the height of the immobilized vehicle.

The method according to the present invention therefore offers the advantage of being easy to implement while ensuring the safety of an operator when working at height. The release of the vehicle according to one step can be carried out manually by an operator. It is also possible to envisage providing the platform with a gripper, particularly robotic, to ensure the release and grasping of the vehicle.

### BRIEF DESCRIPTION OF THE DRAWINGS

Further features, details and advantages will become apparent on reading the detailed description below, and on studying the appended drawings, in which:

FIG. 1 schematically illustrates a view of an example of a transport and storage facility according to one embodiment.

FIG. 2 schematically illustrates a view of an example of a storage rack according to one embodiment.

FIG. 3 and FIG. 4 respectively schematically illustrates two views of an example of storage racks and a maintenance system according to one embodiment.

FIG. 5, FIG. 6, FIG. 7, FIG. 8 and FIG. 9 schematically illustrate a top view in a first vertical direction Z of examples of storage racks and the maintenance system according to one embodiment.

FIG. 10 schematically illustrates a bottom view in the first direction Z of an example of the maintenance system in an engaged configuration (FIG. 10B) and a disengaged configuration (FIG. 10A) respectively of guide members of the maintenance system according to one embodiment.

FIG. 11 schematically illustrates an enlarged view of a deployment mechanism and a prestressing mechanism of the maintenance system according to one embodiment.

FIG. 12 schematically illustrates an enlarged view of a guide member of the maintenance system and climbing means of a vehicle interacting with the same storage rack upright according to one embodiment.

FIG. 13 schematically illustrates steps of a maintenance method according to one embodiment.

### DETAILED DESCRIPTION

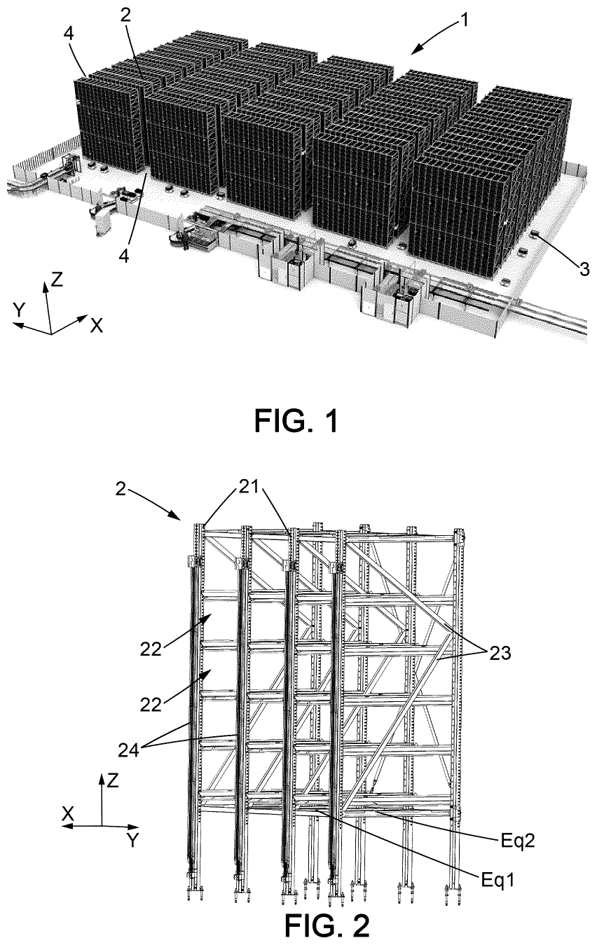

Reference is now made to FIG. 1, which schematically shows an example of a transport and storage facility 1, for example in a warehouse, according to one aspect of the present invention. According to another aspect, the present invention relates to a maintenance system, particularly for such a transport and storage facility 1.

In the description hereinafter, reference is made to a first direction Z, a second direction X and a third direction Y. In the examples shown, the first direction Z coincides with a vertical direction in particular extending vertically from the floor of the transport and storage facility 1. The first direction Z is perpendicular to the second direction X and the third direction Y. The second direction X is perpendicular to the third direction Y. It will therefore be understood that the second direction X and the third direction Y form horizontal directions, here orthogonal to each other.

The transport and storage facility 1 comprises in particular at least two, particularly several, storage racks 2, which can also be denoted by the term “racking”, intended to receive articles for the storage thereof. The storage racks 2 advantageously extend upwards in the first direction Z, to a maximum height greater than or equal to 10 m, particularly greater than or equal to 12 m, preferably greater than or equal to 14 m.

FIG. 2 illustrates such a storage rack 2. Each of the storage racks 2 comprises successive columns of compartments 22, the compartments of each of the columns of compartments 22 being superposed over the height thereof. In particular, each of the compartments 22 defines a bin location intended to receive one or more articles, for example arranged in a bin. Said articles are then brought together to make up orders. More specifically, the successive columns of compartments 22 of each of the storage racks 2 extend in the third direction Y. Access to a compartment 22 in order to place or retrieve an article and/or a bin can take place from at least one of the sides of the storage rack in the second direction X.

Each of the storage racks 22 comprises vertical uprights 21. The upright 21 comprises in particular a straight post extending in the first direction Z. A lower end of the post is configured to be fastened to the floor. The storage rack 2 comprises in particular at least two rows of uprights, in particular two rows of uprights, along the third direction Y. The uprights of each row of uprights are in particular evenly spaced along the third direction Y. Each upright 21 of one of the rows of uprights is aligned with an upright 21 of each of the other rows of uprights in the second direction X. Each compartment 22 is delimited in the third direction Y by two successive uprights 21 of the same row of uprights. Each compartment 22 can further be delimited in the second direction X by at least two uprights 21 in the second direction X of one and another row of uprights 21 respectively. In the example shown in FIG. 2, the storage rack 2 comprises two rows of uprights 21 along the third direction Y. The uprights 21 are held parallel to each other along the first direction Z by a system of braces 23.

The superposed compartments 22 can be defined, for each column of compartments 22, by superposed pairs of fastening interfaces. Each pair of fastening interfaces comprises a first fastening interface Eq1, rigidly connected to at least two uprights 21 in the second direction X, and a second fastening interface Eq2 rigidly connected to at least two other uprights 21 in the second direction X, the at last two uprights 21 rigidly connected to the first fastening interface Eq1 being offset in the third direction Y from the at least two uprights 21 rigidly connected to the second fastening interface Eq2. The first fastening interface Eq1 and the second fastening interface Eq2 comprise support portions, protruding towards each other, for supporting a bin, or more generally a container, in said compartment 22.

The storage racks 2 are arranged so as to form at least one access aisle 4 between respective storage racks 2, particularly aligned relative to each other. More specifically, as illustrated in FIG. 1, at least one access aisle 4, particularly several access aisles, extend in the third direction Y, between two respective storage racks 2. The two storage racks 2 are advantageously facing each other and aligned relative to each other in the third direction Y. At least one access aisle, particularly several access aisles, extend in the second direction X between two respective rows of storage racks 2. Each row of storage racks 2 comprises a series, in the second direction X, of at least two storage racks 2 spaced apart from each other by access aisles extending in the third direction Y. The rows of storage racks 2 are in particular aligned with each other.

The arrangement described above of the transport and storage facility with access aisles extending respectively in the second direction X and the third direction Y makes it possible to facilitate movement within the transport and storage facility, and the placement and retrieval of containers or bins into and from the compartments in a horizontal direction, here the second direction X.

Each of the at least one access aisle(s) 4 between two respective storage racks 2, which extends in particular in the third direction Y, is made up of a plurality of successive vertical access columns. Each vertical access column serves at least one respective column of compartments, for example one column of compartments of one of said two storage racks, or two columns of compartments of one and the other of said two storage racks respectively.

The transport and storage facility 1 can further comprise at least one automated vehicle 3, preferably a plurality of vehicles. The vehicle 3 can be an automated guided vehicle, or AGV. The vehicle 3 is configured to move up or down in one of the vertical access columns 41. To this end, each of the at least one vehicle(s) 3 comprises climbing means suitable for interacting with uprights 21 of the storage racks 2 facing onto said vertical access column 41. More specifically, the vehicle 3 can comprise a chassis and two climbing means on each side of the chassis in the second direction X. The climbing means are for example arranged on the four corners of the chassis and between the chassis and one of the storage racks 2 in the second direction X. The climbing means therefore make it possible to ensure the movement in the first direction Z of the vehicle along the storage racks 2, typically interacting with climbing elements arranged on the uprights 21 in the first direction Z.

The climbing means 31 can comprise at least one motorized toothed wheel, preferably several motorized wheels, typically on the four corners of the chassis of the vehicle. The toothed wheel or each toothed wheel is configured to mesh with a climbing element 24 that can typically be a toothed rack or a roller chain, extending over the height of an upright 21. The vehicle can thus access one of the compartments of the column of compartments accessible from the respective vertical access column in order to place or retrieve a container or a bin into or from the compartment in the second direction X. To this end, the vehicle can comprise a gripping device comprising a support that is movable relative to the chassis and configured to switch from a retracted position in which a bin is loaded on the chassis of the vehicle and in which the support is housed on the chassis, to a deployed unloading position in which the movable support extends protruding from the chassis to unload/deposit the bin, as for example known per se from the applicant's document EP3638607A1.

The transport and storage facility 1 further comprises at least one maintenance system 10 configured to move around in the at least one access aisle 4. The maintenance system is in particular configured to make it possible for an operator to carry out operations at height, particularly assembly and/or maintenance operations, and in particular operations to maintain a vehicle. The vehicle can, in operation, be immobilized at height in a vertical access column, for example due to a breakdown. The vehicle can become positioned at an angle, butted against the climbing elements, that is, the chassis of the vehicle is inclined relative to a horizontal plane perpendicular to the first direction Z. The maintenance system 10 makes it possible for an operator to intervene at height in order to release the vehicle.

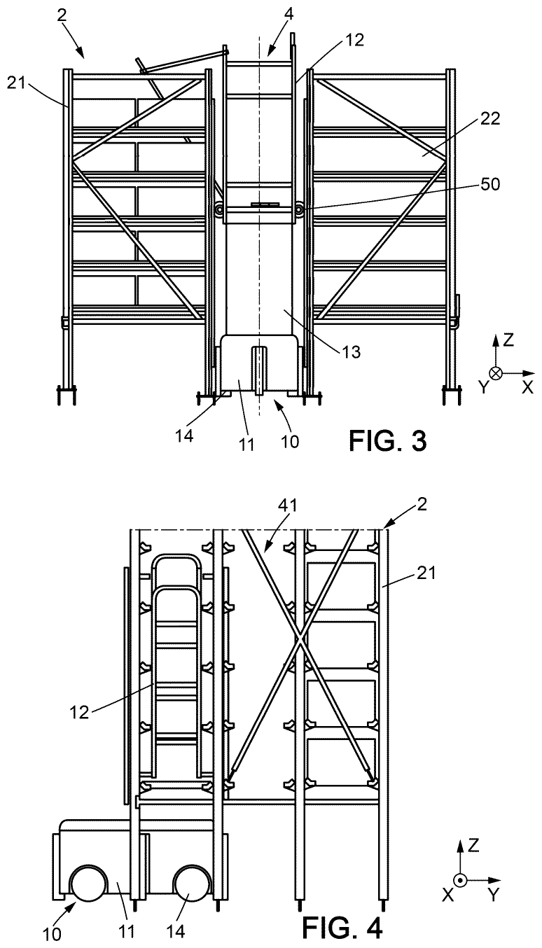

FIGS. 3 and 4 illustrate two views of storage racks 2 defining an access aisle 4 between them, and an example of a maintenance system 10 according to the present invention, in particular for an operation in said access aisle. To ensure the safety and stability of the operator, the base on which the operator is intended to stand is fixed relative to the mobile platform 12, that is, it does not comprise any elements that are movable relative to the platform.

The maintenance system 10 comprises a supporting chassis 11 capable of moving around on the floor in the at least one access aisle 4, a mobile platform 12 intended to receive an operator, and a lifting device 13 interposed between the mobile platform 12 and the supporting chassis 11. The supporting chassis can comprise a motorized or non-motorized vehicle. The supporting chassis 11 can comprise two pairs of wheels 14 for the maintenance system 10 to move around on the floor of the transport and storage facility. The mobile platform 12 comprises in particular a base, extending substantially in a plane perpendicular to the first direction Z, and a guard rail, extending around the periphery of the base. The base and the guard rail form a basket for receiving the operator.

The lifting device 13 comprises at least a base part rigidly connected to the supporting chassis 11, a mobile part rigidly connected to the mobile platform 12, and an extending mechanism configured to deploy the mobile part upwards in order to raise the mobile platform 12, and retract it towards the supporting chassis 11 in a reduced vertical footprint position of the maintenance system 10. The extending mechanism configured to deploy the mobile part upwards in order to raise the mobile platform 12, and retract it towards the supporting chassis 11 in a reduced vertical footprint position of the maintenance system 10, can in particular comprise at least one, for example one or more, telescopic mast(s) or a scissor-lift mechanism. Such a vehicle-mounted maintenance system, capable of deploying upwards and retracting, offers the advantage of being mobile and flexible, and thus of facilitating movement and operations at height within the facility. The maintenance system 10 can be moved easily, typically by movement of the supporting chassis, in said reduced vertical footprint position. In addition, such a maintenance system does not require the installation of structures, for example guiding or anchoring structures, on the floor or ceiling of the transport and storage facility. As a result, such a maintenance system makes it possible to facilitate the movement of vehicles such as AGVs in the access aisles, and even under the storage racks if applicable.

In addition, the maintenance system 10 comprises a device 50 for vertically guiding and stabilizing the mobile platform, comprising at least one guide member 51. The guiding and stabilizing device comprises at least one guide member 51 configured to interact with a storage rack upright 21 facing onto the respective access aisle 4. The vertical guiding and stabilizing device is in particular configured to stabilize the mobile platform at height by pressing against the uprights. This advantageously makes it possible to improve the stability of the maintenance system and as a result to reach more elevated heights with such a flexible and mobile maintenance system.

In short, the maintenance system according to the present invention offers the considerable advantage of being able to be mobile, flexible and having a small footprint, and of being able to reach a more elevated height compared to a maintenance vehicle without a guiding and stabilizing device. The guiding and stabilizing device offers improved stability of the maintenance system, to allow an operator to carry out operations at height in complete safety, while reducing the footprint of the maintenance system, in terms of space occupied on the floor and/or weight. In addition, such a maintenance system does not require the installation of additional infrastructure in the transport and storage facility. The maintenance system can move around freely in the access aisles in the second direction and the third direction respectively.

Preferably, said maintenance system 10 is such that the extending mechanism is configured to deploy the mobile part up to a maximum height greater than or equal to 10 m, particularly greater than or equal to 12 m, and particularly greater than or equal to 14 m. In this context, the supporting chassis 11 can occupy a maximum floor space less than 1,500 mm in length, particularly 1,200 mm, and less than 750 mm in width, particularly 700 mm. The maintenance system can have a height of 2,200 mm in the reduced vertical footprint position. The supporting chassis 11 can advantageously have a weight less than or equal to 500 kg. Space occupied on the floor is given to mean the maximum circumferential area occupied by the maintenance system on the floor. These features make it possible to ensure the flexibility and manoeuvrability of the maintenance system, due to a reduced footprint of the maintenance system in terms of space occupied on the floor and weight, while making it possible to reach an elevated maximum height. Further, the footprint of the maintenance system is advantageously such that it corresponds to a footprint of a conventional commercially available mobile aerial lift, as described above. In particular, the footprint of the mobile platform can correspond to the footprint of an assembly made up of the basket and mast of such a conventional mobile aerial lift. The present invention thus makes it possible to easily adapt a commercially available mobile aerial lift, particularly by adding thereto the vertical guiding and stabilizing device, in order to make it possible to raise the mobile platform over a greater height than the conventional mobile aerial lift without making it necessary to increase the space occupied on the floor of the conventional mobile aerial lift in order to ensure the stability thereof.

The vertical guiding and stabilizing device is described in greater detail below.

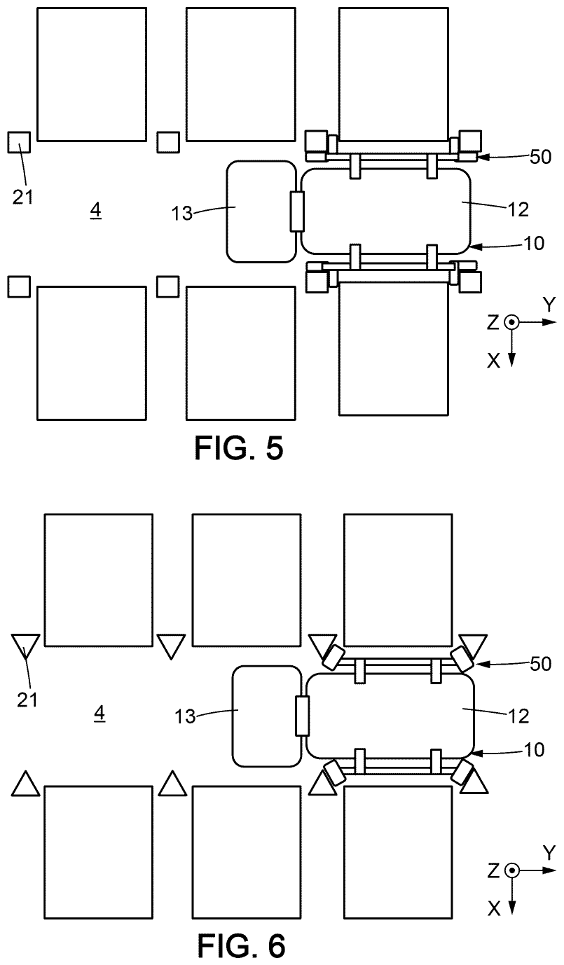

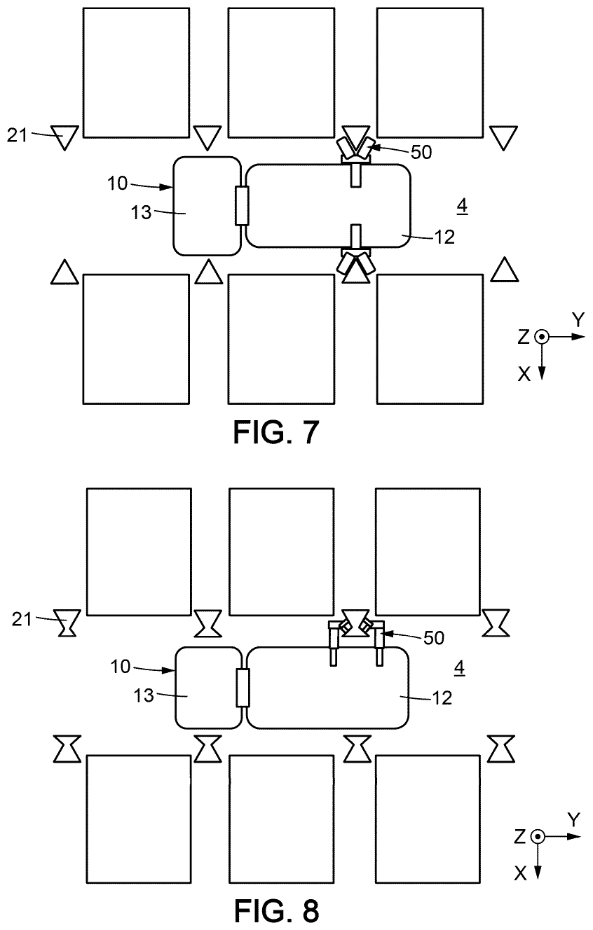

Reference is made to FIGS. 5, 6, 7, 8 and 9, which schematically illustrate a top view of the examples of two storage racks defining an access aisle 4 between them, and a maintenance system 10 positioned in said access aisle 4. It should be noted that the different embodiments described below can be combined with each other.

In general, the mobile platform 12 and/or the mobile part of the extending mechanism 13 can comprise the vertical guiding and stabilizing device 50. As the mobile part of the extending mechanism is rigidly connected to the mobile platform, the guiding and stabilizing device can be positioned on this mobile part while making it possible to guide and stabilize the mobile platform during the extension and retraction thereof. In short, the vertical guiding and stabilizing device must advantageously be able to rise upwards and retract with the chassis, following the raising and lowering movement of the mobile platform to ensure the guiding and stabilizing at height thereof. FIGS. 5, 6, 7 and 8 schematically illustrate examples in which the mobile platform comprises the vertical guiding and stabilizing device. FIG. 9 schematically illustrates an example in which the mobile part of the extending mechanism 13 comprises the vertical guiding and stabilizing device. It can also be envisaged that the mobile platform 12 and the mobile part of the extending mechanism 13 each respectively comprise a vertical guiding and stabilizing device (not shown in the figures).

Further, the vertical guiding and stabilizing device 50 preferably comprises at least one pair of guide members 51. Each guide member of the pair of guide members is in particular configured to press on a respective upright 21 in the same direction but in the opposite way from the pressure of the other guide member of the pair of guide members on a respective upright 21. This makes it possible to ensure improved stability of the mobile platform during the guiding at height of the mobile platform.

The guide members of one pair of guide members, particularly of each pair, can in particular be intended to interact with two uprights 21 respectively positioned on either side of a respective access aisle 4, as illustrated in FIGS. 5, 6, 7 and 9. This makes it possible to ensure that the mobile platform is guided on either side of the respective access aisle. Alternatively, the guide members of one pair of guide members, particularly of each pair, can be intended to interact with the same upright 21, or with two uprights 21 positioned in the same row of uprights. FIG. 8 illustrates an example of a guiding and stabilizing device comprising a pair of guide members, one and the other guide member of the pair of guide members being respectively positioned on either side of the same upright and intended to interact with said same upright.

In addition, the vertical guiding and stabilizing device 50 can comprise one pair of guide members 51, two pairs of guide members 51, or more than two pairs of guide members. The number of pairs of guide members, their configuration and their positioning relative to the maintenance system is in particular suitable for ensuring the stability at height of the mobile platform and the mobile part of the extending mechanism. The number of pairs of guide members and their positioning can particularly correspond to a length of the mobile platform and the maximum height for the deployment of the mobile part of the extending mechanism.

However, the implementation of a guiding and stabilizing device 50 comprising an odd number of guide members 51 can also be envisaged, the important aspect being that the number of guide members 51, their configuration and their positioning make it possible to ensure the stability of the mobile platform, particularly in a plane substantially perpendicular to the first direction Z, during its extension upwards and during its retraction.

FIGS. 5 and 6 schematically show examples of a vertical guiding and stabilizing device comprising two pairs of guide members. In general, the two pairs of guide members can advantageously be spaced so as to interact with successive uprights of a row of uprights. The guide members of the two pairs of guide members can be arranged for example on four corners of the mobile platform.

FIGS. 7, 8 and 9 schematically show examples of a vertical guiding and stabilizing device comprising one pair of guide members. The pair of guide members can in particular be arranged at the opposite end of the mobile platform in the third direction Y from the mobile part of the extending mechanism, as illustrated in FIG. 7. In the example illustrated in FIG. 7, the guide members of the pair of guide members are intended to interact with two uprights 21 respectively positioned on either side of a respective access aisle 4. The pair of guide members can alternatively be arranged in a substantially central position on the mobile platform in the third direction Y, as illustrated in FIG. 8. In the example illustrated in FIG. 8, the guide members of the pair of guide members are intended to interact the same upright 21. The pair of guide members can alternatively be arranged in a substantially central position on the mobile part of the extending mechanism in the third direction Y, as illustrated in FIG. 9. In the example illustrated in FIG. 9, the guide members of the pair of guide members are intended to interact with two uprights 21 respectively positioned on either side of a respective access aisle 4.

As stated above, the implementation of more than two pairs of guide members can also be envisaged. For example, the vertical guiding and stabilizing device comprises three pairs of guide members. The mobile platform can then extend lengthwise over three successive uprights.

In addition, the guide member 51 can in particular be configured to interact with different upright profiles. More specifically, the guide member 51 can be configured to come up against at least one bearing surface of a respective upright, the bearing surface extending in a plane the normal of which is perpendicular to the first direction Z. For example, the guide member can be configured to come up against a single bearing surface, or two bearing surfaces of a respective upright, or even more than two bearing surfaces. The interaction of the guide members with the bearing surfaces is particularly suitable for preventing the movement of the guiding and stabilizing device in a plane perpendicular to the first direction Z when it is engaged on the uprights.

When the guide member is configured to come up against a single bearing surface, the plane of the bearing surface can advantageously have one component in the second direction X and one component in the third direction Y. FIG. 6 illustrates such an example in which the guiding and stabilizing device comprises four guide members, each configured to come up against a single bearing surface of a respective upright. This configuration makes it possible to prevent the movement of the guiding and stabilizing device in a plane perpendicular to the first direction Z when it is engaged on the uprights.

When the guide member is configured to come up against two bearing surfaces, the planes of the bearing surfaces are advantageously not collinear with each other. This configuration makes it possible to prevent the movement of the guiding and stabilizing device in a plane perpendicular to the first direction Z when it is engaged on the uprights. FIGS. 5, 7, 8 and 9 schematically illustrate examples in which the guide member is configured to come up against two bearing surfaces. The plane of one of the two bearing surfaces can have a normal perpendicular to the second direction X, and the plane of the other of the two bearing surfaces can have a normal perpendicular to the third direction Y. Such an example is illustrated in FIG. 5. Alternatively, the planes of the two bearing surfaces can each have one component in the second direction X and one component in the third direction Y, as illustrated in FIGS. 7, 8 and 9.

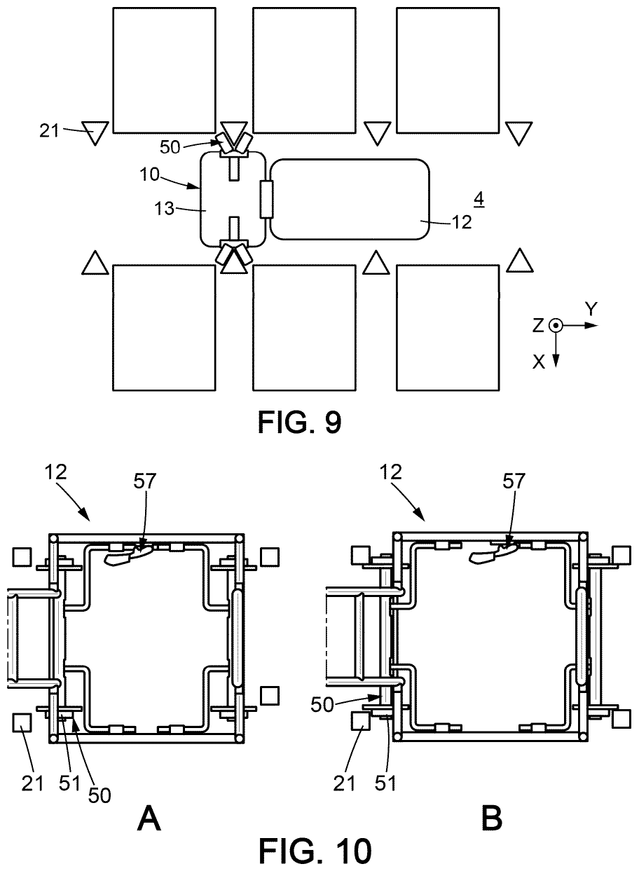

Further, the vertical guiding and stabilizing device 50 can advantageously comprise a deployment mechanism 57 configured to switch said at least one guide member 51 of the vertical guiding and stabilizing device 50 from a disengaged position from an upright 21 to an engaged position with the respective upright 21. FIGS. 10A and 10B illustrate an example of a maintenance system 10 in a disengaged position and in an engaged position respectively of the at least one guide member 51. The implementation of a deployment mechanism advantageously makes it possible to reduce the footprint of the maintenance system when the at least one guide member is not in the engaged position on the respective upright, particularly when the maintenance system is moving around in an access aisle.

The deployment mechanism can comprise, or even consist of, a mechanical deployment mechanism. Mechanical deployment mechanism is given to mean a deployment mechanism capable of being triggered manually by an operator. For example, the deployment mechanism 57 can comprise at least one clamping device, such as a mechanical pull action clamp, configured to deploy or retract the at least one guide member. The at least one guide member can in particular be mounted on a bar, the bar being mounted on the clamping device. The clamping device then makes it possible to deploy and retract the bar. In particular, a plurality of guide members, for example two guide members, can be mounted on the same bar, as illustrated in FIGS. 10A and 10B.

However, other deployment mechanisms can be envisaged. For example, the deployment mechanism can comprise, or even consist of, a motorized deployment mechanism, an electromagnet-operated deployment mechanism, or a hydraulic deployment mechanism comprising a hydraulic and/or pneumatic cylinder for example.

Further, the vertical guiding and stabilizing device 50 can comprise a prestressing mechanism 54 intended to exert pressure from said at least one guide member 51 against an upright 21. This makes it possible to compensate for any play between the guide member and the upright along the latter. In particular, when the aim is to reach elevated heights, as in this invention, the upright can have a deflection relative to the first direction Z. The prestressing mechanism makes it possible to compensate for this deflection and ensure the stability of the mobile platform up to the maximum height that it can reach.

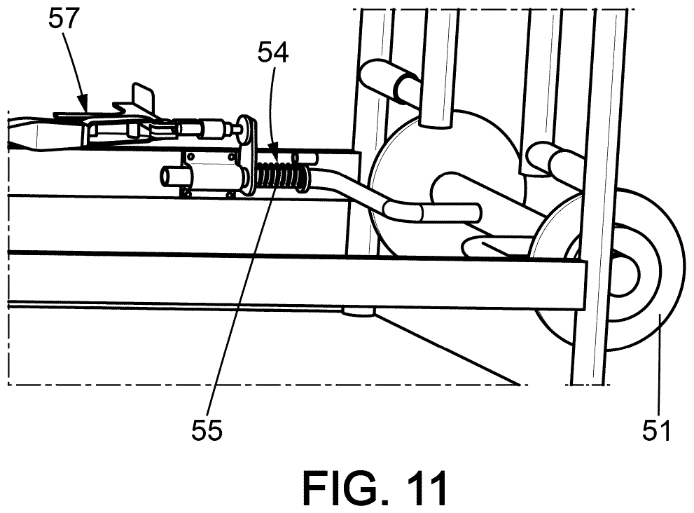

According to an embodiment illustrated in FIG. 11, the prestressing mechanism 54 comprises a spring member 55 configured to elastically stress said at least one guide member 51 onto the upright 21, compensating for play over the height of the uprights 21. The deployment mechanism can comprise an operating device configured to switch said at least one spring member 55 from a less stressed, or even unstressed, state in the disengaged position of said at least one guide member 51, to a more stressed state of said at least one guide member, in the engaged position of the guide member 51.

In addition, the at least one guide member is advantageously configured to ensure linear guiding of the mobile platform 12 along the respective upright 21. The guiding must in particular make it possible to ensure that the guide member presses against the upright while limiting the friction of the guide member and the respective upright.

Said at least one guide member 51 of said vertical guiding and stabilizing device 50 can particularly comprise at least one vertical guide wheel intended to roll against an upright 21. The guide member 51 can for example comprise one or two guide wheels. The vertical guide wheel has in particular an axis of rotation perpendicular to a longitudinal direction of the upright 21.

Alternatively, the guide member can be configured to ensure linear ball guiding of the mobile platform 12 along the respective upright 21. More specifically, the guide member can comprise balls arranged in a cage, and the respective upright can have at least one guide groove having a shape complementary to the shape of the balls in order to allow the balls to roll against the at least one respective guide groove. This type of guiding makes it possible to reduce the contact friction and pressure between the surfaces of the guide member and the upright, thus offering precise movement of the guide member relative to the upright.

The guide member can be configured to ensure linear roller guiding of the mobile platform 12 along the respective upright 21. To this end, the guide member can comprise one or more cylindrical rollers. This type of guiding makes it possible to reduce the friction between the guide member and the upright. This type of guiding has the advantage of being more durable and being able to withstand heavier loads than ball guiding.

The guide member can be configured to ensure linear shoe guiding of the mobile platform 12 along the respective upright 21. This type of guiding makes it reduce the friction between the sliding surfaces between the guide member and the respective upright. This type of guiding is in particular advantageous for applications requiring rapid, repetitive movements.

The guide member can be configured to ensure linear magnetic guiding of the mobile platform 12 along the respective upright 21. This type of guiding in particular implements magnetic fields to make it possible to support the load of the mobile platform. This type of guiding offers the advantage of limiting the friction between the guide member and the upright, and ensuring precision and a large load capacity.

The guide member can be configured to ensure linear slider guiding of the mobile platform 12 along the respective upright 21. The guide member can be configured to interact with the respective upright in the form of a guide rail. In particular, the guide member and the respective upright are configured to be in surface-to-surface contact with each other so as to form a sliding connection. The guide member and the respective upright are particularly made from a material having a sufficiently low coefficient of friction to allow satisfactory operation of the sliding connection. The guide member and the guide rail can be made from steel for example. This solution has the advantage of being simple and low-cost. It can be advantageous in applications requiring linear movements to travel over long distances. However, this solution is less precise and less wear-resistant than the other guiding solutions described above.

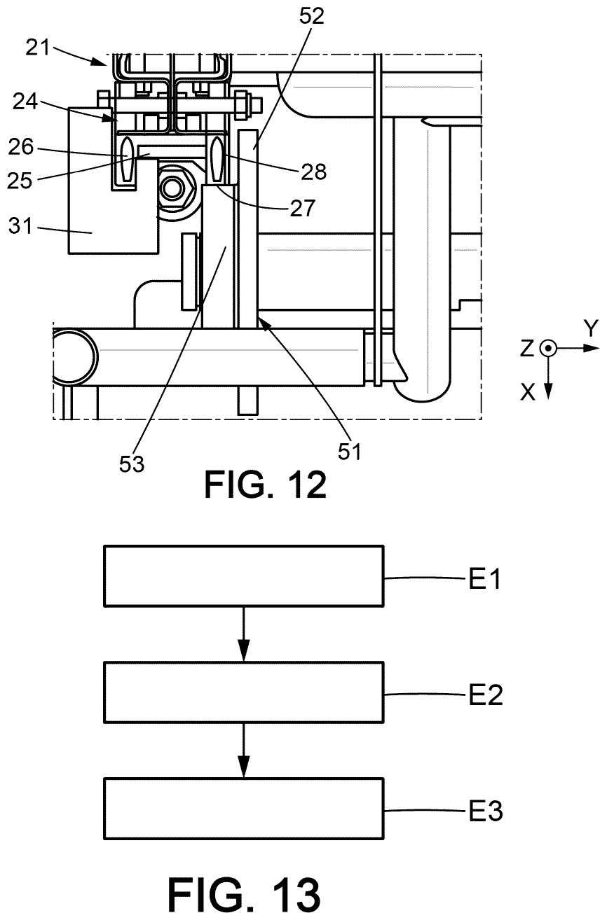

Reference is made to FIG. 12, which schematically shows an enlarged view of a guide member interacting with an upright 21. Preferably, and generally, the climbing means 31 of the at least one vehicle 3 arranged in a vertical access column and the vertical guiding and stabilizing device 50 of the mobile platform 12 guided in an adjacent access column, are configured to interact simultaneously with the same upright 21 of one of the storage racks 2 without hindering the movement, along the direction of the upright 21, of the respective vehicle 3 or the respective mobile platform 12 relative to said same upright 21. This feature advantageously makes it possible to bring the maintenance system as close as possible to an immobilized vehicle to perform maintenance on it.

The climbing means 31 schematically illustrated in FIG. 12 in particular can be a motorized toothed wheel of the vehicle, that meshes with a climbing element 24 rigidly connected to an upright 21, particularly a toothed rack (or a roller chain), only on a first lateral portion of said climbing element, adjacent to the access column of the vehicle, while a second lateral portion of said climbing element 24, adjacent to the access column inside which the maintenance system is guided, is left free for the movement of said guide member 51, particularly a roller pressing on the guide member. The guide member 51, and more generally the mobile platform, can thus be moved upwards in an access column, without interference with an AGV immobilized in an adjacent access column. The toothed rack comprises a main wall 25 extending in the first direction Z and facing the vertical access column, and two lateral walls 26, each arranged at a respective end of the main wall 25 in the third direction Y. Each lateral wall 26 extends in the first direction Z and protruding relative to the main wall in the second direction X. It will be noted that said guide member 51 can be a roller comprising in particular:
a first rolling surface 53 configured to ensure the guiding of the platform via rolling interaction with a first guide surface 27 of one of the lateral walls 26 of the toothed rack, in order to ensure the stabilization of the mobile platform in the second direction X,
a shoulder 52 protruding from the rolling surface 53 configured to interact with a second guide surface 28 of one of the lateral walls 26 of the toothed rack in order to ensure the stabilization of the mobile platform in the third direction Y.

Further, generally, said supporting chassis 11 can be provided with at least one horizontal guiding device 60 extending lengthwise along the supporting chassis 11 and configured to interact with elements of storage racks 2, in discontinuous positions along the length of the access aisle 4 in order to ensure the guiding of the maintenance system 10 along the access aisle 4. It is thus easier to correctly position the maintenance system in the access aisle 4 in order to be able to facilitate the manoeuvrability of the maintenance system and the engagement of the maintenance system on the uprights.

FIG. 13 schematically illustrates a maintenance method, according to one aspect of the present invention, for a transport and storage facility 1 when a vehicle is immobilized at height in a vertical access column of the transport and storage facility 1.

Generally, the method comprises:
moving E1 the maintenance system 10 to a vertical access column 41 succeeding a vertical access column 41 in which a vehicle 3 is immobilized,
coupling E2 the guide member of the vertical guiding and stabilizing device 50 to an upright 21 facing onto the respective access aisle 4,
deploying E3 the mobile platform 12 to the height of the immobilized vehicle 3.

The method according to the present invention therefore offers the advantage of being easy to implement while ensuring the safety of an operator when working at height. The release of the vehicle according to a step E4 can be carried out manually by an operator. It is also possible to envisage providing the platform with a gripper, particularly robotic, to ensure the release and grasping of the vehicle.

1. A maintenance system for a transport and storage facility comprising storage racks arranged so as to form at least one access aisle between two respective storage racks, the storage racks comprising vertical uprights, the maintenance system comprising:
a supporting chassis capable of moving around on the floor in at least one access aisle,
a mobile platform intended to receive an operator,
a lifting device interposed between the mobile platform and the supporting chassis, the lifting device comprising least a base part rigidly connected to the supporting chassis, a mobile part rigidly connected to the mobile platform, and an extending mechanism configured to deploy the mobile part upwards in order to raise the mobile platform, and retract it towards the supporting chassis in a minimal vertical footprint position of the maintenance system, and
a vertical guiding and stabilizing device for the mobile platform, the vertical guiding and stabilizing device comprising at least one guide member configured to interact with an upright facing onto the respective access aisle, and in that the mobile platform comprises a base extending substantially in a plane perpendicular to the vertical direction, and a guard rail extending around the periphery of the base.

2. The maintenance system according to claim 1, wherein the vertical guiding and stabilizing device comprises a deployment mechanism configured to move said at least one guide member of the vertical guiding and stabilizing device from a disengaged position from an upright into an engaged position with the respective upright.

3. The maintenance system according to claim 1, wherein said at least one guide member is configured to ensure linear guiding of the mobile platform along the respective upright.

4. The maintenance system according to claim 1, wherein said at least one guide member of said vertical guiding and stabilizing device comprises at least one vertical guide wheel intended to roll against an upright, the vertical guide wheel having an axis of rotation perpendicular to a longitudinal direction of the upright.

5. The maintenance system according to claim 1, wherein said vertical guiding and stabilizing device comprises a prestressing mechanism intended to exert pressure from said at least one guide member against an upright.

6. The maintenance system according to claim 5, wherein the prestressing mechanism comprises a spring member configured to elastically stress said at least one guide member onto the upright, compensating for play over the height of the uprights.

7. The maintenance system according to claim 2, wherein the deployment mechanism comprises an operating device configured to move said at least one spring member from a less stressed, or even unstressed, state in the disengaged position of said at least one guide member, to a more stressed state of said at least one guide member, in the engaged position of the guide member.

8. The maintenance system according to claim 1, wherein the vertical guiding and stabilizing device comprises at least one pair of guide members, intended to interact with uprights respectively positioned on either side of a respective access aisle.

9. The maintenance system according to claim 1, wherein said maintenance system is such that the extending mechanism is configured to deploy the mobile part up to a maximum height greater than or equal to 10 m, the maintenance system having a weight less than or equal to 500 kg and occupying, a maximum floor space:
less than 1,500 mm in length,
less than 750 mm in width.

10. The maintenance system according to claim 1, wherein the supporting chassis comprises two pairs of wheels for moving the system on the floor.

11. The maintenance system according to claim 1, wherein said supporting chassis is provided with at least one horizontal guiding device extending lengthwise along the supporting chassis and configured to interact with elements of storage racks, in discontinuous positions along the length of the access aisle in order to ensure the guiding of the maintenance system along the access aisle.

12. The maintenance system according to claim 1, wherein the extending mechanism configured to deploy the mobile part upwards in order to raise the mobile platform, and retract it towards the supporting chassis in the reduced vertical footprint position of the maintenance system, comprises at least one telescopic mast or a scissor-lift mechanism.

13. A transport and storage facility comprising storage racks comprising successive columns of compartments, the storage racks being arranged so as to form at least one access aisle between two respective storage racks, the storage racks comprising vertical uprights,
the facility further comprising a maintenance system according to claim 1, configured to move around in the at least one access aisle, the at least one guide member of the vertical guiding and stabilizing device of the maintenance system being configured to interact with a storage rack upright facing onto a respective access aisle.

14. The facility according to claim 13, each of the at least one access aisle(s), between two respective storage racks, being made up of a plurality of successive vertical access columns, each vertical access column serving at least one respective column of compartments, wherein the facility further comprises at least one automated vehicle configured to move up or down in a vertical access column, each of the at least one vehicle(s) comprising climbing means suitable for interacting with uprights of the storage racks facing onto said vertical access column.

15. The facility according to claim 14, wherein the climbing means of one of the at least one vehicle(s) arranged in a vertical access column and the vertical guiding and stabilizing device of the mobile platform guided in an adjacent access column, are configured to interact simultaneously with the same upright of one of the storage racks without hindering the movement, along the direction of the upright, of the respective vehicle or the respective mobile platform relative to said same upright.

16. A method for maintaining a facility according to claim 14, the method comprising:
moving the maintenance system to a vertical access column succeeding a vertical access column in which a vehicle is immobilized.
coupling the guide member of the vertical guiding and stabilizing device to an upright facing onto the respective access aisle.
deploying the mobile platform to the height of the immobilized vehicle.
